(19) United States
(12) Patent Application Publication
(10) Pub. No.: US 2026/0140884 A1
(43) Pub. Date: May 21, 2026

(54) ADDRESS RANGE IDENTIFICATION

(71) Applicant: Arm Limited, Cambridge (GB)

(72) Inventors: Henrique Duarte Hachmeister CARAÇA, Zurich (CH); Damien Matthieu Valentin CATHRINE, Mougins (FR); Ugo CASTORINA, Biot (FR); Diogo Augusto Pereira MARQUES, Antibes (FR)

(21) Appl. No.: 18/955,045

(22) Filed: Nov. 21, 2024

(51) Int. Cl. G06F 12/10; G06F 12/0811; G06F 12/0862

(52) U.S. Cl. CPC G06F 12/10; G06F 12/0615; G06F 12/0811; G06F 12/0862

(57) ABSTRACT

There is provided an apparatus comprising storage circuitry to store a plurality of entries each identifying a corresponding contiguous range of addresses spanning one or more of a plurality of addressable regions. Content stored at each of the plurality of addressable regions is individually retrievable by fetch circuitry. The apparatus is also provided with control circuitry to store information indicative of a candidate new entry identifying a contiguous range of addresses. The control circuitry is responsive to receipt of an indication of a memory access request specifying an addressable region other than one of the plurality of addressable regions which is both contiguous with and subsequent to the contiguous range of addresses, to determine if the addressable region is within a predefined range. The control circuitry is responsive to the addressable region being within the predefined range, to modify the contiguous range of addresses to include the addressable region.

### TECHNICAL FIELD

The present invention relates to data processing. More particularly the present invention relates to an apparatus, a system, a chip containing product, a method, and a computer-readable medium.

### BACKGROUND

Some apparatuses are provided with storage circuitry to store entries identifying contiguous ranges of addresses at which content to be retrieved from memory is stored.

### SUMMARY

According to a first aspect of the present techniques there is provided an apparatus comprising:
storage circuitry configured to store a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, and wherein each of the plurality of entries is suitable to be used for generation of one or more speculative memory access requests for retrieval of the content stored at the corresponding contiguous range of addresses in response to a trigger condition being satisfied; and
control circuitry configured:
   to store information indicative of a candidate new entry identifying a contiguous range of addresses spanning one or more of the plurality of addressable regions;
   in response to receipt of an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, to perform a determination of whether the addressable region is within a predefined range of the contiguous range of addresses; and
   in response to the addressable region being within the predefined range of the contiguous range of addresses, to modify the contiguous range of addresses to include the addressable region.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method comprising:
storing a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, wherein each of the plurality of entries is suitable to be used for generation of one or more speculative memory access requests for retrieval of the content stored at the corresponding contiguous range of addresses in response to a trigger condition being satisfied;
storing information indicative of a candidate new entry identifying a contiguous range of addresses spanning one or more of the plurality of addressable regions; in response to receiving an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, performing a determination of whether the addressable region is within a predefined range of the contiguous range of addresses; and
in response to the addressable region being within the predefined range of the contiguous range of addresses, modifying the contiguous range of addresses to include the addressable region.

According to a fifth aspect of the present techniques there is provided a non-transitory computer-readable medium storing computer-readable code for fabrication of an apparatus comprising:
storage circuitry configured to store a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, and wherein each of the plurality of entries is suitable to be used for generation of one or more speculative memory access requests for retrieval of the content stored at the corresponding contiguous range of addresses in response to a trigger condition being satisfied; and
control circuitry configured:
   to store information indicative of a candidate new entry identifying a contiguous range of addresses spanning one or more of the plurality of addressable regions;
   in response to receipt of an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, to perform a determination of whether the addressable region is within a predefined range of the contiguous range of addresses; and in response to the addressable region being within the predefined range of the contiguous range of addresses, to modify the contiguous range of addresses to include the addressable region.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an addressable region according to some configurations of the present techniques;

FIG. 4 schematically illustrates an addressable region according to some configurations of the present techniques;

FIG. 5 schematically illustrates an addressable region according to some configurations of the present techniques;

FIG. 6 schematically illustrates an addressable region according to some configurations of the present techniques;

FIG. 7 schematically illustrates addresses requested in some examples of the present techniques;

FIG. 8 schematically illustrates addresses requested in some examples of the present techniques;

FIG. 9 schematically illustrates addresses requested in some examples of the present techniques;

FIG. 10 schematically illustrates addresses requested in some examples of the present techniques;

FIG. 11 schematically illustrates addresses requested in some examples of the present techniques;

FIG. 12 schematically illustrates addresses requested in some examples of the present techniques;

FIG. 13 schematically illustrates a sequence of steps carried out according to some configurations of the present techniques;

FIG. 14 schematically illustrates a sequence of steps carried out according to some configurations of the present techniques; and

FIG. 15 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

Some configurations of the present techniques provide an apparatus comprising storage circuitry configured to store a plurality of entries, each of the plurality of entries identifying a corresponding contiguous range of addresses spanning one or more of a plurality of addressable regions of an address space. Content stored at each of the plurality of addressable regions is individually retrievable by fetch circuitry from a memory hierarchy. Each of the plurality of entries is suitable to be used for generation of one or more speculative memory access requests for retrieval of the content stored at the corresponding contiguous range of addresses in response to a trigger condition being satisfied. The apparatus also comprises control circuitry configured to store information indicative of a candidate new entry identifying a contiguous range of addresses spanning one or more of the plurality of addressable regions. The control circuitry is configured to, in response to receipt of an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, to perform a determination of whether the addressable region is within a predefined range of the contiguous range of addresses. The control circuitry is configured, in response to the addressable region being within the predefined range of the contiguous range of addresses, to modify the contiguous range of addresses to include the addressable region.

The apparatus is provided with storage circuitry to store entries indicating contiguous ranges of addresses. The entries are of a form suitable to be used in the generation of speculative memory accesses to retrieve content stored at the contiguous range of addresses from a memory hierarchy and into a local storage structure. The contiguous range of addresses identify one or more of a plurality of addressable regions of an address space where each addressable region can be individually retrieved (e.g., individually requested, individually accessed, and/or individually received) by fetch circuitry from the memory hierarchy. In other words, fetch circuitry associated with the apparatus is capable of retrieving content from each addressable region without simultaneously retrieving content from another addressable region (e.g., an adjacent addressable region). The size of each addressable region is therefore greater than or equal to a size of the smallest amount of memory that the fetch circuitry can retrieve from the memory hierarchy. Whilst the addressable regions are each individually retrievable, the fetch circuitry may also (i.e., in addition to being able to individually retrieve content from the addressable regions) be capable of retrieving multiple contiguous ones of the addressable regions at a same time and/or be capable of issuing a request for multiple contiguous ones of the addressable regions at a same time.

The content stored at the addressable regions may comprise any type of content or data. However, in some configurations the content comprises instructions (e.g., data that is indicative of instructions to be performed by decoded by decoder circuitry to cause processing circuitry to perform one or more operations according to those instructions). The instructions may be, for example, instructions identified in an instruction set architecture (ISA) which can be decoded by decoder circuitry associated with the apparatus for execution by processing circuitry associated with the apparatus. The contiguous range can, in such configurations, be considered as identifying a basic block of instructions, e.g., a group or set of instructions that are defined as being contiguous in program counter order and that may be comprised between branch instructions, i.e., flow altering instructions that cause the instructions to be executed in an order other than the sequential order defined by the program counter. Each entry in the plurality of entries can therefore be used to identify a contiguous basic block of instructions to be retrieved by the fetch circuitry for processing. Storing entries identifying the contiguous regions in this way enables speculative retrieval of instructions (or other content) from the contiguous range of addresses when it is identified that program flow has been diverted to (or is predicted to be diverted to) that contiguous range of addresses.

The control circuitry is provided to identify addressable regions which can be combined into a new entry to be stored in the storage circuitry through the monitoring of memory access requests. The control circuitry identifies the addressable regions that can be combined into a new entry by storing a candidate new entry identifying a contiguous range of addresses spanning one or more of the plurality of addressable regions. Whilst it would be possible to define the contiguous range of addresses by storing data indicative of a first addressable region (e.g., as identified in a first memory request) and identifying whether a next memory request is a memory request for a second addressable region that is contiguous with the first addressable region and that sequentially follows the first addressable region, the inventors have recognised that such an approach would not be appropriate for identifying cases where a contiguous range of instructions are executed in an order other than the order in which they are defined in memory (e.g., program counter order). For example, this would make such an approach inappropriate for use in the case of out-of-order processing. The control circuitry is therefore arranged to be responsive to receipt of a memory access request specifying an addressable region which is a region other than the addressable region that is both contiguous with the first addressable region and that sequentially follows the first addressable region, to perform a determination of whether the addressable region falls within a predefined range of the contiguous address range. In other words, the control circuitry is configured to perform the determination in response to receipt of a memory access request that is received out-of-order with respect to the addressable regions already comprised in the contiguous address range.

By way of an illustrative example, if each addressable region can be identified by an address A and the candidate new entry comprises a contiguous range of addresses including, as the sequentially final addressable region, an addressable region Ai (where i is an integer used to distinguish a particular addressable region), then the addressable region that is both contiguous with and subsequent to the addressable region Aᵢ is addressable region Aᵢ₊₁, i.e., the addressable region that follows on from region Aᵢ in program counter order. Whilst, in an in-order example, the control circuitry could potentially identify addressable regions to be incorporated into the contiguous range by looking for address Aᵢ₊₁, this approach may miss cases in which the addressable regions are received out of order, for example, if the addressable regions were identified in the order Aᵢ, Aᵢ₊₂, Aᵢ₊₁. The control circuitry in the present configurations is therefore responsive to receipt of an addressable region (e.g., Aⱼ, where j is an integer and j≠i+1) of the plurality of addressable regions that is a region other than Aᵢ₊₁ (i.e., other than the one of the plurality addressable regions which is both contiguous with and subsequent to Aᵢ) to determine if the addressable region Aⱼ is within a predefined range of the contiguous region. An addressable region (e.g., Aⱼ) is determined to be within the predefined range of the contiguous range of addresses if the number of addressable regions between the contiguous range of addresses and the addressable region Aⱼ satisfies a predefined condition. For example, the predefined condition may be a threshold condition requiring that the addressable region Aⱼ and the contiguous range of addresses are sufficiently close in the address space that it is either likely that they are part of a contiguous range of instructions, or that the potential cost of incorrectly fetching content of addressable regions between the addressable region Aⱼ and the contiguous range of addresses is insignificant. Specific examples of the predefined range will be set out below.

When the addressable region is within the predefined range of the contiguous range, then the control circuitry modifies the contiguous range to include the addressable region along with the existing addresses identified in the contiguous range. In other words, the contiguous range is extended so that it comprises the previous contiguous range and the addressable region. The control circuitry is therefore able to define a contiguous range of addresses for cases in which the addressable regions are received out-of-order and, hence, the definition of the entries can be expanded to encompass a greater range of use cases. As a result, the storage circuitry is able to accommodate processing activities in which speculative memory access requests can be generated to retrieve content from a contiguous range of addressable regions in cases of out-of-order processing and/or when the addressable regions have not been received by control circuitry in the expected order.

The control circuitry may, in some configurations, also be responsive to receipt of memory access requests specifying an addressable region that is both contiguous and subsequent to the contiguous range, to modify the contiguous range to include the addressable region.

The control circuitry may, in some configurations, also be responsive to receipt of memory requests specifying an addressable region that falls within the contiguous range (either because of a repeated memory access request or because the contiguous range has previously been extended to incorporate the addressable region), to maintain the current contiguous range (i.e., without modification).

In some configurations the control circuitry is responsive to the determination identifying at least one intervening region between the contiguous range of addresses and the addressable region, to modify the contiguous range of addresses to include the at least one intervening region. For example, the contiguous region may comprise addressable regions Aᵢ through to Aₖ (where i and k are integers and k is greater than i) and the addressable region received by the control circuitry is region A_{k+N}, where N is an integer greater than 1. The control circuitry is responsive to receipt of such an addressable region, when N is both greater than one and less than the predefined range, to extend the contiguous range to incorporate addressable regions in the range from Aᵢ to A_{k+N} so that the contiguous range also includes all intervening addressable regions, i.e., the addressable regions between Aₖ and A_{k+N}. Including the intervening regions in this way allows the control circuitry to handle sequences of memory access requests where memory access requests may be received out of order.

In some configurations the control circuitry is configured to implement a restriction on a total number of intervening regions. The restriction may relate to a total number of times that intervening regions can be included within the contiguous range, e.g., a restriction on the number of times that the contiguous range of addresses can be modified to include one or more intervening regions regardless of the number of intervening regions that are included each time the contiguous range is modified. Alternatively, or in addition, the restriction may restrict (limit) a total number of intervening regions that can be included within the contiguous range. This may be implemented, for example, by tracking addresses (or address offsets) of addressable regions within the contiguous range that have not been received by the control circuitry. When the total number of addressable regions that are tracked, i.e., that are not subsequently received by the receiving circuitry, exceeds a threshold, the control circuitry may restrict the modification of the contiguous range to only allow modification of the contiguous range to include addressable regions that are contiguous with the existing contiguous range.

Whilst the restriction may be based on a fixed threshold, for example, hardwired into the control circuitry, in some configurations the restriction is based on a total size of the contiguous range of addresses. In other words, the restriction may be placed on a total fraction of the contiguous range that is comprised of intervening regions that have not been specified in received requests. For example, the total number of intervening regions may be restricted to one plus an additional one for every N_{T} addressable regions, where N_{T} is the total number of addressable regions included in the contiguous range.

Alternatively, or in addition, in some configurations the restriction is based on a performance metric of the one or more speculative memory access requests. For example, the restriction may be based on a timeliness of the one or more speculative memory access requests or an accuracy metric associated with the one or more speculative memory access requests. Where the performance metric indicates that the one or more speculative memory access requests are timely and/or accurate, the restriction may be relaxed so that a greater number of intervening regions can be included in the contiguous range. Where the performance metric indicates that the one or more speculative memory access requests are not timely and/or not accurate, the restriction may be tightened so that fewer intervening regions can be included in the contiguous range. The feedback between the speculative memory access requests and the restriction allows the control circuitry to tune the definition of the contiguous ranges specified in the entries so that when the speculative memory access requests are performing well, the amount of addressable regions that can be accessed may be increased allowing the control circuitry to account for a greater amount of out-of-order execution, and when the speculative memory access requests are not performing well, the amount of addressable regions that can be accessed may be restricted.

Whilst the addressable regions may be of different sizes with the predefined range being defined in terms of a range of the address space, in some configurations each of the plurality of addressable regions has a predefined size and the predefined range is defined in terms of the predefined size. Defining the predefined range in terms of the predefined size allows for a more compact implementation that does not need to determine the size difference between different regions at the resolution of the address space.

In some configurations the predefined range comprises addressable regions within a first range sequentially prior to the contiguous range of addresses and within a second range sequentially subsequent to the contiguous range of addresses. In other words, the start of the contiguous region that is identified in the candidate new entry is not fixed. Rather, the contiguous range in the candidate new entry may be modified, in response to receipt of the addressable region, to include an addressable region that is before the contiguous range (i.e., is within the first range) in terms of the address of the addressable region (e.g., in terms of program counter order).

Whilst the first range and the second range may be the same, e.g., be of the same size, in some configurations the first range and the second range are different. For example, the first range may contain fewer addressable regions than the second range or a greater number of addressable regions than the second range. In some configurations the first region contains only the addressable region that immediately precedes the contiguous range. In other configurations, the first region contains plural addressable regions that precede the contiguous range. Similarly, the second range may include only the addressable region that is subsequent to the contiguous range and that is separated from the contiguous range by one or more intervening addressable regions (e.g., a single intervening addressable region or plural intervening addressable regions). Alternatively, the second range may include plural addressable regions that are subsequent to the contiguous range and that are separate from the contiguous range by one or more intervening addressable regions. The definition of different first and second ranges introduces additional flexibility.

In general, the contiguous range may be identified by any two of: an address identifying a sequentially first region spanned by the contiguous range, a sequentially last region spanned by the contiguous range, and an indication of a size of the contiguous range. In some configurations the control circuitry is configured: to store first address data identifying a sequentially first region spanned by the contiguous range of addresses and size data indicating a size of the contiguous range of addresses; in response to the addressable region being sequentially subsequent to the contiguous range of addresses, to extend the size data to include the addressable range. For example, the first address data may be stored as a full 32-bit or 64-bit address and the size data may comprise integer data indicating a number of the addressable regions. Where the addressable region is sequentially subsequent to the contiguous range, the first address data can be retained without modification.

In some configurations the control circuitry is responsive to the addressable region being sequentially before the contiguous range of addresses, to replace the first address data with the addressable region and to extend the size data to include the addressable range. Where the addressable region is sequentially before the contiguous range both the size data and the first address data need to be modified to incorporate the addressable region into the contiguous range. The modification may comprise replacing the first address data with the address data identifying the addressable region and increasing the size data by the difference between the previous first address data and the address of the addressable region.

Whilst the predefined range may be fixed, for example, hardwired in circuitry, in some configurations the predefined range is dynamically adjusted based on one or more performance parameters. For example, the predefined range may be increased in response to the one or more performance parameters indicating a high level of performance (e.g., a level of performance that falls within a range defining a high level of performance) and may be decreased in response to the performance parameters indicating a low level of performance (e.g., a level of performance that falls within a range defining a low level of performance).

The one or more performance parameters may relate to any parameters of the apparatus. However, in some configurations the one or more performance parameters are indicative of a performance metric of the one or more speculative memory access requests. As a result, the predefined range may be tailored to the performance metric of the speculative memory accesses allowing the predefined range to be increased when the speculative memory access requests are timely and/or accurate and to be decreased when the speculative memory access requests are not timely and/or not accurate.

In some configurations the apparatus comprises a local storage structure, wherein each of the plurality of addressable regions is the size of an entry in the local storage structure. The local storage structure may be a dedicated instruction storage structure configured to store instructions, or a dedicated data storage structure configured to store data (e.g., data that is not going to be interpreted by the processing circuitry as instructions). In some configurations the local storage structure may be shared between a plurality of instances of processing circuitry. In some configurations the local storage structure may be a dedicated storage structure for a single instance of processing circuitry, e.g., a processing pipeline.

In some configurations the local storage structure is a cache and each of the plurality of addressable regions is a cache line. The cache may be an L1 data cache or an L1 instruction cache. Alternatively, the cache may be a shared L2 cache configured to store instructions and data, and/or shared between plural instances of processing circuitry.

In some configurations the determination is performed over a window of memory access requests. The control circuitry may be configured to consider only a single candidate new entry over the window of memory access requests or, may be configured to consider plural candidate new entries of the window of memory access requests. A window of memory access requests may be of a fixed length, i.e., a fixed number of memory access requests, or may be defined in terms of a number of received memory accesses specifying an addressable region that is not within the predefined range without receiving a memory access request specifying an addressable region that is within the predefined range. The number of received memory access requests may be set to a hardwired threshold or a threshold that varies based on a performance metric, e.g., a performance metric associated with the speculative memory access requests.

In some configurations the control circuitry is configured to store the candidate new entry in the storage circuitry as one of the plurality of entries. The control circuitry may be configured to determine whether or not to store the candidate new entry as one of the plurality of entries based on a total size of the contiguous range. Alternatively, the control circuitry may be configured to store all candidate new entries independent of the total size of the contiguous range.

Particular configurations will now be described with reference to the figures.

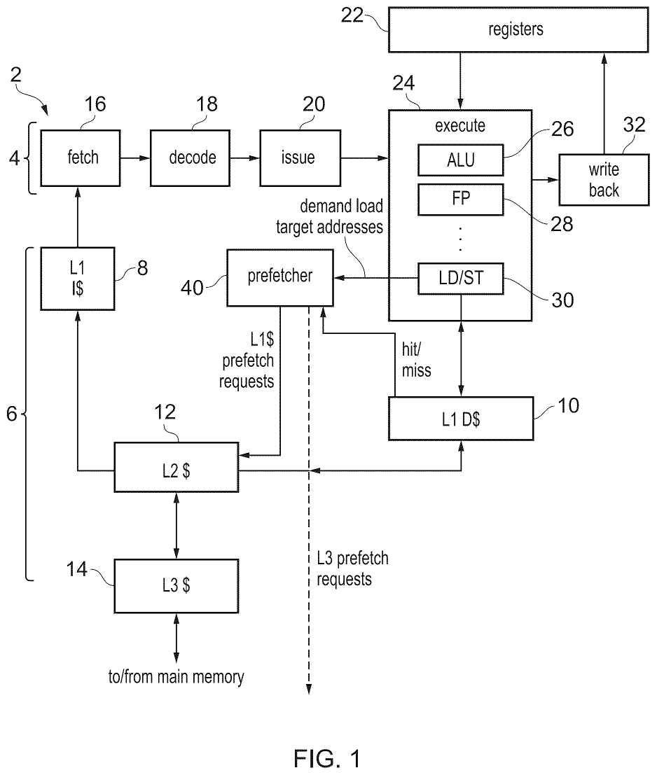

FIG. 1 illustrates an example of a data processing apparatus 2. The apparatus has a processing pipeline 4 for processing program instructions fetched from a memory system 6. The memory system (memory hierarchy) in this example includes a level 1 instruction cache 8, a level 1 data cache 10, a level 2 cache 12 shared between instructions and data, a level 3 cache 14, and main memory which is not illustrated in FIG. 1 but may be accessed in response to requests issued by the processing pipeline 4. It will be appreciated that other examples could have a different arrangement of caches with different numbers of cache levels or with a different hierarchy regarding instruction caching and data caching (e.g. different numbers of levels of cache could be provided for the instruction caches compared to data caches).

The processing pipeline 4 includes a fetch stage 60 for fetching program instructions from the instruction cache 8 or other parts of the memory system 6. The fetched instructions are decoded by a decode stage 18 to identify the types of instructions represented and generate control signals for controlling downstream stages of the pipeline 4 to process the instructions according to the identified instruction types. The decode stage passes the decoded instructions to an issue stage 20 which checks whether any operands required for the instructions are available in registers 22 and issues an instruction for execution when its operands are available (or when it is detected that the operands will be available by the time they reach the execute stage 24). The execute stage 24 includes a number of functional units 26, 28, 30 for performing the processing operations associated with respective types of instructions. For example, in FIG. 1 the execute stage 24 is shown as including an arithmetic/logic unit (ALU) 26 for performing arithmetic operations such as add or multiply and logical operations such as AND, OR, NOT, etc. Also the execute unit includes a floating point unit 28 for performing operations involving operands or results represented as a floating-point number. Also the functional units include a load/store unit 30 for executing load instructions to load data from the memory system 6 to the registers 22 or store instructions to store data from the registers 22 to the memory system 6. Load requests issued by the load/store unit 30 in response to executed load instructions may be referred to as demand load requests discussed below. Store requests issued by the load/store unit 30 in response to executed store instructions may be referred to as demand store requests. The demand load requests and demand store requests may be collectively referred to as demand memory access requests. It will be appreciated that the functional units shown in FIG. 1 are just one example, and other examples could have additional types of functional units, or could have multiple functional units of the same type, or may not include all of the types shown in FIG. 1 (e.g. some processors may not have support for floating-point processing). The results of the executed instructions are written back to the registers 22 by a write back stage 32 of the processing pipeline 4.

It will be appreciated that the pipeline architecture shown in FIG. 1 is just one example and other examples could have additional pipeline stages or a different arrangement of pipeline stages. For example, in an out-of-order processor a register rename stage may be provided for mapping architectural registers specified by program instructions to physical registers identifying the registers 22 provided in hardware. Also, it will be appreciated that FIG. 1 does not show all of the components of the data processing apparatus and that other components could also be provided. For example, a branch predictor may be provided to predict outcomes of branch instructions so that the fetch stage 16 can fetch subsequent instructions beyond the branch earlier than if waiting for the actual branch outcome. Also a memory management unit could be provided for controlling address translation between virtual addresses specified by the program instructions and physical addresses used by the memory system.

As shown in FIG. 1, the apparatus 2 has a prefetcher 40 for analysing patterns of demand target addresses specified by demand memory access requests issued by the load/store unit 30, and detecting stride sequences of addresses where there are a number of addresses separated at regular intervals of a constant stride value. The prefetcher 40 uses the detected stride address sequences to generate prefetch load requests which are issued to the memory system 6 to request that data is brought into a given level of cache. The prefetch load requests are not directly triggered by a particular instruction executed by the pipeline 4, but are issued speculatively with the aim of ensuring that when a subsequent load/store instruction reaches the execute stage 24, the data it requires may already be present within one of the caches, to speed up the processing of that load/store instruction and therefore reduce the likelihood that the pipeline has to be stalled. The prefetcher 40 may be able to perform prefetching into a single cache or into multiple caches. For example, FIG. 1 shows an example of the prefetcher 40 issuing level 1 cache prefetch requests which are sent to the level 2 cache 12 or downstream memory and request that data from prefetch target addresses is brought into the level 1 data cache 10. Also the prefetcher 40 in this example can also issue level 3 prefetch requests to the main memory requesting that data from prefetch target addresses is loaded into the level 3 cache 14. The level 3 prefetch request may look a longer distance into the future than the level 1 prefetch requests to account for the greater latency expected in obtaining data from main memory into the level 3 cache 14 compared to obtaining data from a level 2 cache into the level 1 cache 10. In systems using both level 1 and level 3 prefetching, the level 3 prefetching can increase the likelihood that data requested by a level 1 prefetch request is already in the level 3 cache. However, it will be appreciated that the particular caches loaded based on the prefetch requests may vary depending on the particular circuit of implementation.

It would be readily apparent to the skilled person that a stride based prefetcher, such as the one described in relation to FIG. 1 is merely one example of a possible prefetcher. The prefetcher may, in some configurations, predict access patterns based on a producer-consumer relationship between two memory access instructions. The person of ordinary skill in the art would appreciate that the prefetch generation circuitry can be of any form and use any algorithm to generate the prefetch requests.

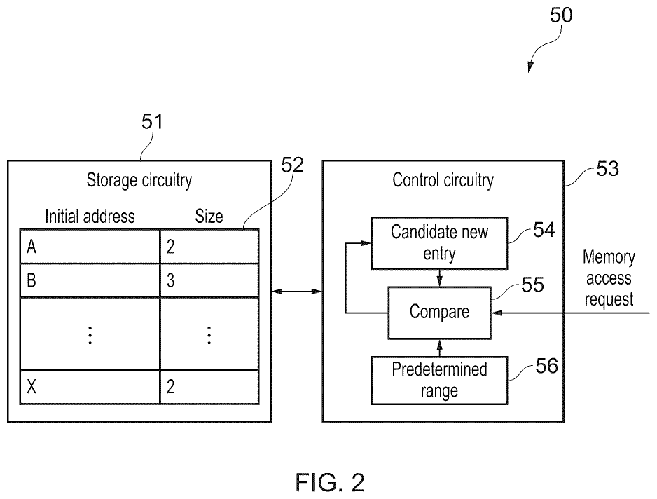

FIG. 2 schematically illustrates an apparatus 50 according to some configurations of the present techniques. The apparatus 50 is provided with storage circuitry 51 and control circuitry 53. The storage circuitry 51 is arranged to store a plurality of entries 52. Each of the plurality of entries 52 identifies a corresponding contiguous range of address spaces spanning from an initial address to cover a plurality of addressable regions including the addressable region identified by the initial address. Each addressable region stores content that is individually retrievable by fetch circuitry. In other words, content from a given addressable region can be retrieved without also retrieving content from an addressable region adjacent to the given addressable region. Each of the plurality of entries 52 identifies a size indicative of a number of the contiguous regions of address space that are spanned by the contiguous range of addresses in that region. In the illustrated configuration, the plurality of entries 52 comprises a first entry identifying an initial address A and a size of 2 indicating that the first entry has a contiguous range of addresses starting at address A and including 2 addressable regions in addition to region A, i.e., regions A, A+1 and A+2. The plurality of entries 52 also includes a second entry identifying an initial address B and a size of 3 indicating that the first entry has a contiguous range of addresses starting at address B and including 3 addressable regions in addition to region B, i.e., regions B, B+1, B+2 and B+3. The plurality of entries 52 also includes an N-th entries (with one or more entries omitted for clarity of illustration) identifying an initial address X and a size of 2 indicating that the first entry has a contiguous range of addresses starting at address X and including 2 addressable regions in addition to region X, i.e., regions X, X+1 and X+2. Each of the plurality of entries 52 is suitable for being used by prefetch circuitry (an example of a speculative structure configured to generate speculative memory access requests), for example, the prefetcher 40 illustrated in relation to FIG. 1 to generate one or more speculative memory requests to trigger instructions (an example of content) to be retrieved from a memory hierarchy in response to a trigger condition being satisfied.

The control circuitry 53 is configured to store information indicative of a candidate new entry 54 identifying a contiguous range of addresses spanning one or more of the plurality of addressable regions. The control circuitry 53 is also configured to receive memory access requests identifying an addressable region of the plurality of addressable regions. The memory access request is received by comparison circuitry 55 within the control circuitry 53. The comparison circuitry 55 also receives a determination of the contiguous range identified in the candidate new entry 54 and a predetermined range 56. The comparison circuitry 55 is configured to determine if the addressable region identified in the memory access request is within the predetermined range 56 of the contiguous range defined in the candidate new entry 54. In other words, and as will be explained in further detail below, the comparison circuitry 55 is configured to identify, when the addressable region is a region other than the addressable region that is both contiguous with and subsequent to the contiguous range, whether the addressable region falls within the predetermined range 56 of the contiguous region identified in the candidate new entry 54. Where the addressable region does fall within the predetermined range 56 of the contiguous range identified in the candidate new entry 54, then the control circuitry 53 causes the contiguous range identified in the candidate new entry 54 to be modified to include the addressable region. Where the addressable region identified in the memory access request is the addressable region that is both contiguous with and subsequent to the contiguous range, the control circuitry 53 updates the candidate new entry 54 to include the addressable region.

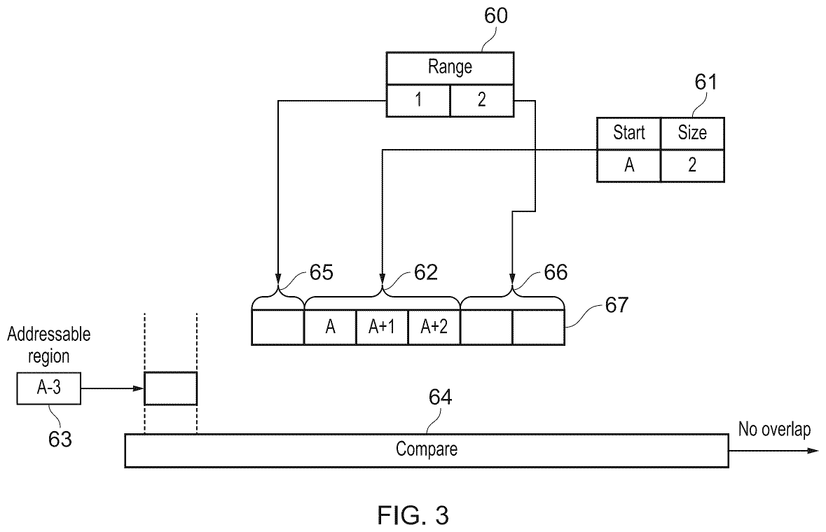

FIGS. 3 to 6 schematically illustrate an example use case in which a candidate new entry is modified in response to a sequence of addressable regions identified in memory access requests. FIG. 3 schematically illustrates the candidate new entry 61 having an initial address A and a size of 2, indicating that, in addition to the addressable region having address A, there are two further addressable regions included in the candidate new entry 61. The candidate new entry 61 identifies a contiguous range 62 spanning addressable region A, A+1 and A+2. On receipt of a memory access request specifying an addressable region 63, in this case the region having an address A-3, the addressable region 63 is compared against the contiguous range 62 by comparison circuitry 64 to determine if the addressable region 63 falls within a predefined range 60 of the contiguous region 61. The predefined range 60 comprises a first range and a second range. In the illustrated configuration, the first range is 1 and the second range is 2. The first range identifies a first set of addressable regions 65, in this case a single addressable region prior to the contiguous range 62, and the second range identifies a second set of addressable regions 66, in this case two addressable regions subsequent to the contiguous range 62. The first set of addressable regions 65 is contiguous with the contiguous range 62 and the second set of addressable regions 66 is contiguous with the contiguous range 62. The comparison circuitry 64 is configured to determine whether the addressable region 63 falls within the range of addressable regions 67 composed of the first set of addressable regions 65, the second set of addressable regions 66 and the contiguous range 62. The addressable region 63 having address A−3 does not fall within the range of addressable regions 67 and, hence, the candidate new entry 61 is not modified in response to receipt of the memory access request identifying the addressable region 63.

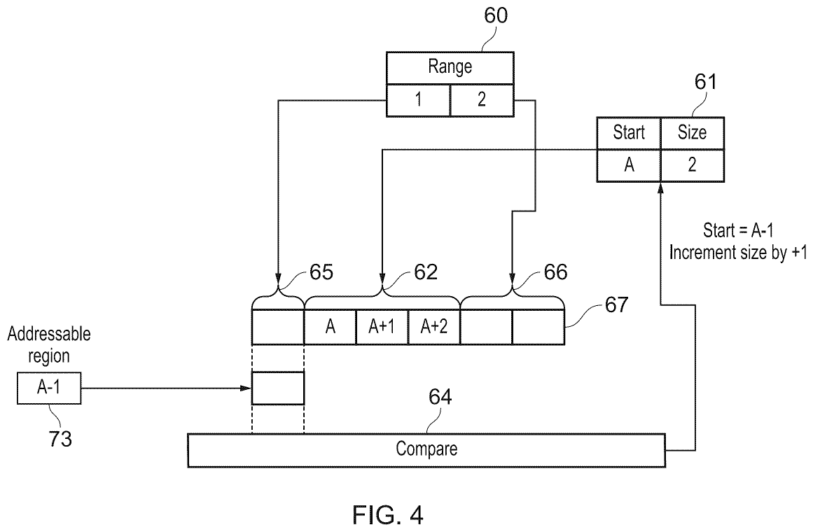

FIG. 4 schematically illustrates receipt of a further memory access request identifying addressable region 73 having an address of A−1. The addressable region 73 having an address of A−1 falls within the range of addressable regions 67, in particular, it is the region that is contiguous with the contiguous range 62 and that occurs before the contiguous range 62. The comparison circuitry 64 identifies that the addressable region 73 falls within the range of addressable regions 67 and triggers a modification to the candidate new entry 61. In particular, the contiguous range 62 identified in the candidate new entry 61 is modified so that the start address becomes A−1 and the size is incremented by 1 resulting in a candidate new entry that expands the contiguous range 62 to include the addressable region 73.

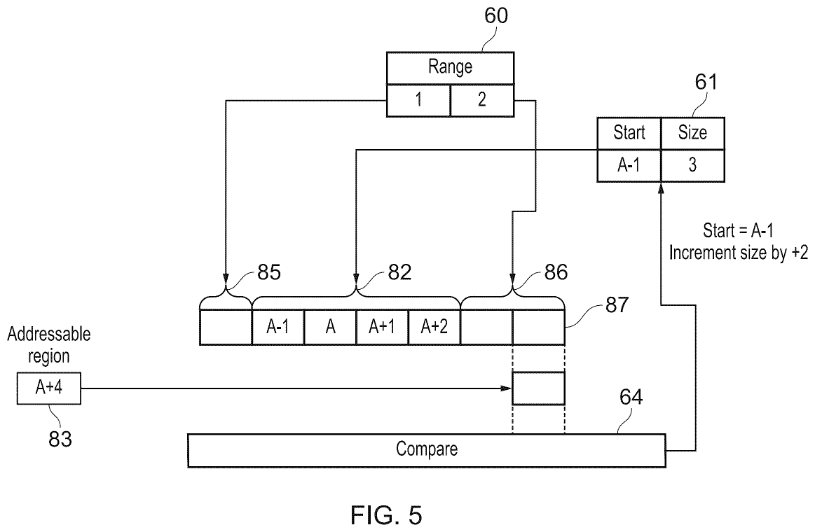

FIG. 5 schematically illustrates receipt of a further memory access request identifying addressable region 83 having an address of A+4. The candidate new entry 61 has been updated in response to receipt of the addressable region 73 described in relation to FIG. 4. As a result, the contiguous range 82 spans the addressable regions from A−1 to A+2. The first set of addressable regions 85 comprises the region A-2, and the second set of addressable regions 86 comprises addressable regions A+3 and A+4. The comparison circuitry 64 is configured to determine whether the addressable region 83 falls within the range of addressable regions 87 composed of the first set of addressable regions 65, the second set of addressable regions 86 and the contiguous range 82. The addressable region 83 having an address of A+4 falls within the range of addressable regions 87, in particular, it is the region that is non-contiguous with the contiguous range 82, but that falls within the second set of addressable regions 86. The comparison circuitry 64 identifies that the addressable region 83 falls within the range of addressable regions 87 and triggers a modification to the candidate new entry 61. In particular, the contiguous range 82 identified in the candidate new entry 61 is modified so that the start address remains A−1 and the size is incremented by 2 resulting in a candidate new entry that expands the contiguous range 82 to include the addressable region 83.

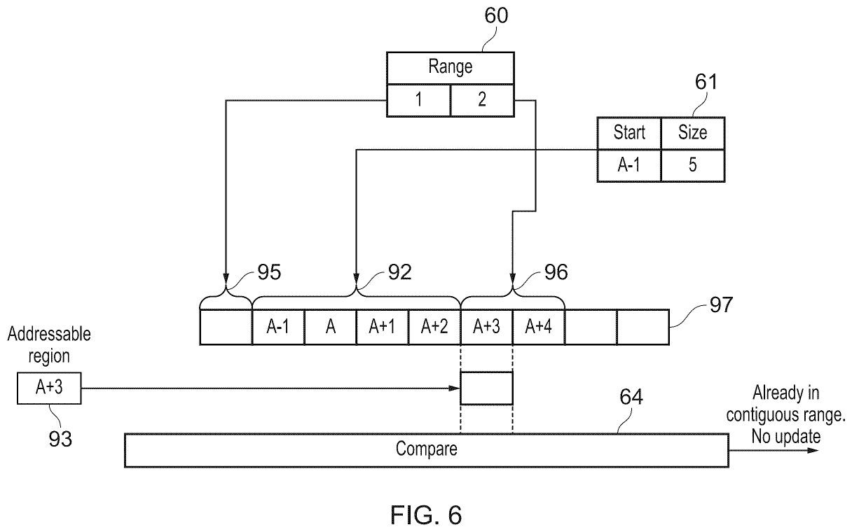

FIG. 6 schematically illustrates receipt of a further memory access request identifying addressable region 93 having an address of A+3. The candidate new entry 61 has been updated in response to receipt of the addressable region 83 described in relation to FIG. 5. As a result, the contiguous range 92 spans the addressable regions from A−1 to A+4. The first set of addressable regions 95 comprises the region A−2, and the second set of addressable regions 96 comprises addressable regions A+5 and A+6. The comparison circuitry 64 is configured to determine whether the addressable region 93 falls within the range of addressable regions 97 composed of the first set of addressable regions 95, the second set of addressable regions 96 and the contiguous range 92. The addressable region 93 having an address of A+3 falls within the range of addressable regions 97, in particular, it is the contiguous range 92 that is already defined in the candidate new entry. The comparison circuitry 64 identifies that the addressable region 93 falls within the contiguous range 92 and determines that no update to the candidate new entry 61 is required because the addressable region 93 is already covered by the contiguous range.

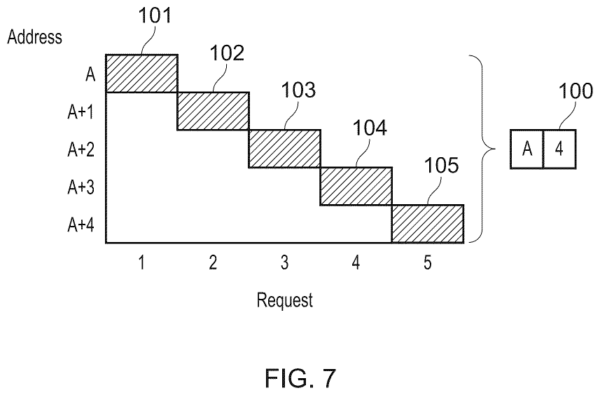

FIG. 7 schematically illustrates an example sequence of memory access requests received by the control circuitry according to some configurations of the present techniques. The control circuitry receives a first memory access request identifying addressable region A 101. Subsequently, the control circuitry receives a second memory access request identifying addressable region A+1 102. Subsequently, the control circuitry receives a third memory access request identifying addressable region A+2 103. Subsequently, the control circuitry receives a fourth memory access request identifying addressable region A+3 104. Subsequently, the control circuitry receives a fifth memory access request identifying addressable region A+4 105. The memory access requests are received in order and the control circuitry identifies that the five memory access requests identify a contiguous range (contiguous set) of addressable regions. In response to receipt of the five memory access requests the control circuitry generates the entry 100 identifying the first addressable region A and that, in addition to the addressable region A, four further addressable regions are included in the contiguous range identified in the candidate entry.

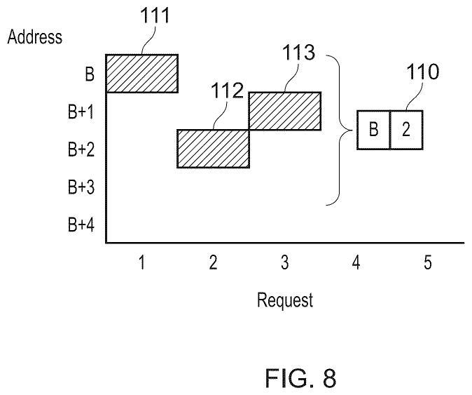

FIG. 8 schematically illustrates a further example sequence of memory access requests received by the control circuitry according to some configurations of the present techniques. The control circuitry receives a first memory access request identifying addressable region B 111. Subsequently, the control circuitry receives a second memory access request identifying addressable region B+2 112. Subsequently, the control circuitry receives a third memory access request identifying addressable region B+1 113. The memory access requests are received out of order with respect to the order in which the regions are addressed, i.e., the second memory access request identifying addressable region B+2 112 is received before the third memory access request identifying addressable region B+1 113. The control circuitry is responsive to receipt of the first memory access request identifying the addressable region B 111, to generate a candidate new entry identifying the addressable region B 111. The control circuitry is responsive to receipt of the second memory access request identifying addressable region B+2 112 (i.e., a region other than the region that is both subsequent to and contiguous with the addressable region B 111), to determine if the addressable region B+2 falls within a predefined range of the contiguous range in the candidate new entry. In the illustrated configuration, it is assumed that the second memory access request falls within the predefined range of the contiguous range (currently comprising addressable region B 111) and the contiguous range is therefore updated to identify the candidate new entry 110 identifying the first addressable region B 111 and that, in addition to the addressable region B 111, two further addressable regions are included in the contiguous range identified in the candidate entry. The control circuitry is responsive to receipt of the third memory access request for the addressable region B+1 113, to identify that the addressable region B+1 113 already falls within the contiguous range identified in the candidate new entry 110 and the candidate new entry is not further modified.

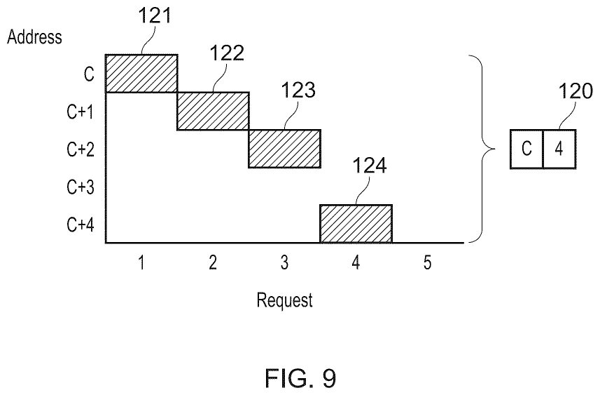

FIG. 9 schematically illustrates a further example sequence of memory access requests received by the control circuitry according to some configurations of the present techniques. The control circuitry receives a first memory access request identifying addressable region C 121. Subsequently, the control circuitry receives a second memory access request identifying addressable region C+1 122. Subsequently, the control circuitry receives a third memory access request identifying addressable region C+2 123. Subsequently, the control circuitry receives a fourth memory access request identifying addressable region C+4 124 without receiving a memory access request identifying the intervening region C+3. The memory access requests are received in order with respect to the order in which the regions are addressed. However, the addressable regions are not all contiguous with one another because no memory access request is received for addressable region C+3. The control circuitry is responsive to receipt of the first memory access request identifying the addressable region C 121, the second memory access request identifying the addressable region C+1 122, and the third memory access request identifying the addressable region C+2 123, to generate a candidate new entry identifying a contiguous range including addressable region C 121, addressable region C+1 122, and addressable region C+2 123. The control circuitry is responsive to receipt of the fourth memory access request identifying addressable region C+4 124 (i.e., a region other than the region that is both subsequent to and contiguous with the addressable region C 121, the addressable region C+1 122 and the addressable region C+2 123), to determine if the addressable region C+4 124 falls within a predefined range of the contiguous range in the candidate new entry. In the illustrated configuration, it is assumed that the fourth memory access request falls within the predefined range of the contiguous range and the contiguous range is therefore updated to identify the candidate new entry 120 identifying the first addressable region C 121 and that, in addition to the addressable region C 121, four further addressable regions are included in the contiguous range identified in the candidate new entry 120.

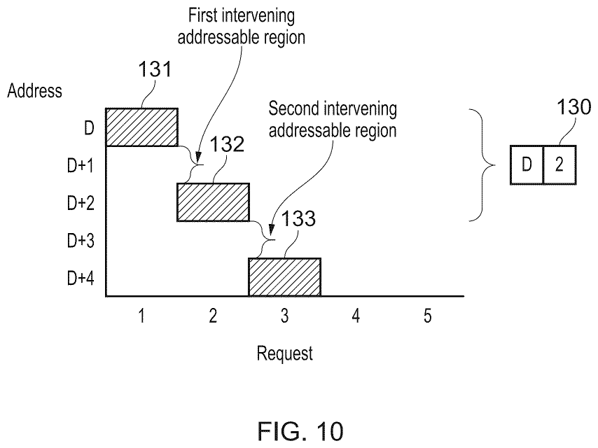

FIG. 10 schematically illustrates a further example sequence of memory access requests received by the control circuitry according to some configurations of the present techniques. The control circuitry receives a first memory access request identifying addressable region D 131. Subsequently, the control circuitry receives a second memory access request identifying addressable region D+2 132. Subsequently, the control circuitry receives a third memory access request identifying addressable region D+4 133. The memory access requests are received in order with respect to the order in which the regions are addressed. However, the addressable regions are not contiguous because no memory access request is received for a first intervening addressable region D+1 or for a second intervening addressable region D+3. It is further assumed that, in the illustrated configuration, the control circuitry sets a restriction (i.e., a limit) on the maximum number of intervening addressable regions of one intervening region. The control circuitry is responsive to receipt of the first memory access request identifying the addressable region D 131, to generate a candidate new entry identifying a contiguous range including addressable region D 121. The control circuitry is responsive to receipt of the second memory access request identifying addressable region D+2 132 (i.e., a region other than the region that is both subsequent to and contiguous with the addressable region D 131), to determine if the addressable region D+2 132 falls within a predefined range of the contiguous range in the candidate new entry. In the illustrated configuration, it is assumed that the second memory access request falls within the predefined range of the contiguous range and the contiguous range is therefore updated to identify the candidate new entry 130 identifying the first addressable region D 131 and that, in addition to the addressable region D 131, two further addressable regions are included in the contiguous range identified in the candidate new entry 130. On receipt of the third memory access request identifying the addressable region D+4 133, the control circuitry determines that the total number of intervening addressable regions that have not been received by the control circuitry is two which exceeds the restriction placed on the number of intervening addressable regions. Therefore, the addressable region D+4 is not included in the candidate new entry 130. In other words, addressable region D+4 is not included because we have already seen one jump in the sequence of addressable regions identified in the requests.

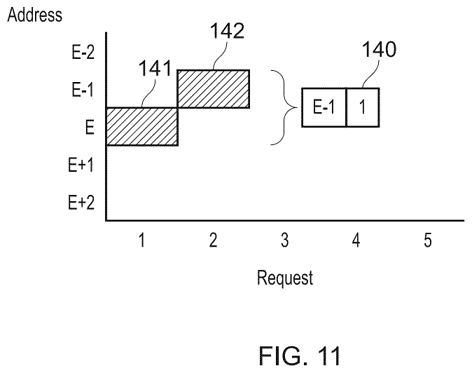

FIG. 11 schematically illustrates a further example sequence of memory access requests received by the control circuitry according to some configurations of the present techniques. The control circuitry receives a first memory access request identifying addressable region E 141. Subsequently, the control circuitry receives a second memory access request identifying addressable region E−1 142. The memory access requests are received out of order with respect to the order in which the regions are addressed, i.e., the first memory access request identifying addressable region E 141 is received before the second memory access request identifying addressable region E−1 142. The control circuitry is responsive to receipt of the first memory access request identifying the addressable region E 141, to generate a candidate new entry identifying the addressable region E 141. The control circuitry is responsive to receipt of the second memory access request identifying addressable region E−1 142 (i.e., a region other than the region that is both subsequent to and contiguous with the addressable region E), to determine if the addressable region E−1 142 falls within a predefined range of the contiguous range in the candidate new entry. In the illustrated configuration, it is assumed that the second memory access request falls within the predefined range of the contiguous range (currently comprising addressable region E 141) and the contiguous range is therefore updated to identify the candidate new entry 140 identifying the second addressable region E−1 142 and that, in addition to the addressable region E−1 142, a further addressable region is included in the contiguous range identified in the candidate entry 140.

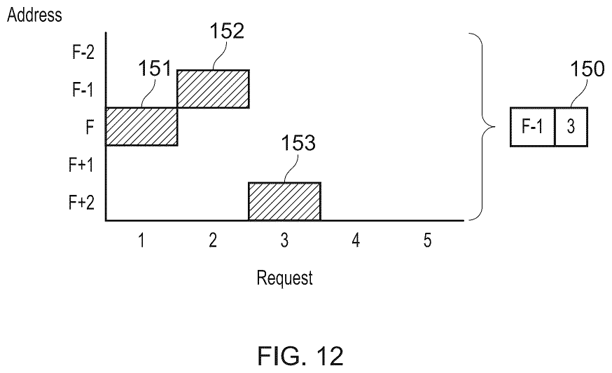

FIG. 12 schematically illustrates a further example sequence of memory access requests received by the control circuitry according to some configurations of the present techniques. The control circuitry receives a first memory access request identifying addressable region F 151. Subsequently, the control circuitry receives a second memory access request identifying addressable region F−1 152. Subsequently, the control circuitry receives a third memory access request identifying addressable region F+2 153. The memory access requests are received out of order with respect to the order in which the regions are addressed, i.e., the first memory access request identifying addressable region F 151 is received before the second memory access request identifying addressable region F−1 152. The control circuitry is responsive to receipt of the first memory access request identifying the addressable region F 151, to generate a candidate new entry identifying the addressable region F 151. The control circuitry is responsive to receipt of the second memory access request identifying addressable region F−1 152 (i.e., a region other than the region that is both subsequent to and contiguous with the addressable region F), to determine if the addressable region F−1 152 falls within a predefined range of the contiguous range in the candidate new entry. In the illustrated configuration, it is assumed that the second memory access request falls within the predefined range of the contiguous range (currently comprising addressable region F 151) and the contiguous range is therefore modified to include the addressable region F−1 152. The control circuitry is responsive to receipt of the third memory access request identifying addressable region F+2 153 (i.e., a region other than the region that is both subsequent to and contiguous with the addressable region F 151 and the addressable region F−1 152 included in the contiguous range), to determine if the addressable region F+2 153 falls within a predefined range of the contiguous range in the candidate new entry. In the illustrated configuration, it is assumed that the third memory access request falls within the predefined range of the contiguous range (currently comprising addressable region F 151 and the addressable region F−1 152) and the contiguous range is therefore modified to include the addressable region F+2 153. The control circuitry therefore generates the candidate new entry 150 identifying the second addressable region F−1 152 and that, in addition to the addressable region F−1 152, a further three addressable regions are included in the contiguous range identified in the candidate entry 150.

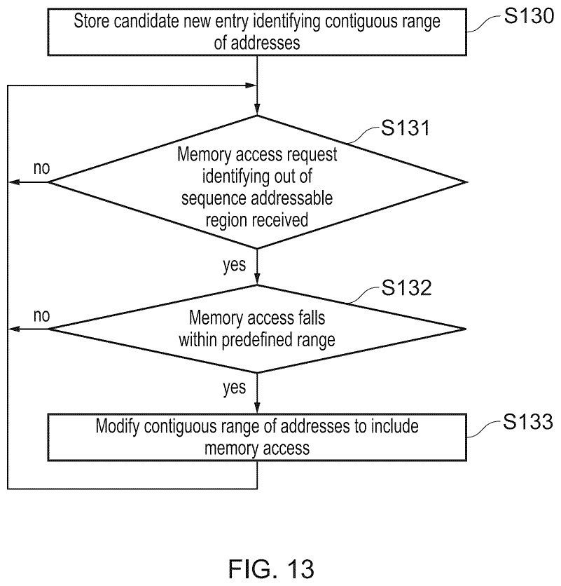

FIG. 13 schematically illustrates a sequence of steps carried out according to some configurations of the present techniques. Flow begins at step S130 where a candidate new entry is stored. The candidate new entry identifies a contiguous range of one or more addresses. Flow then proceeds to step S131 where it is determined if a memory access request identifying an out of sequence addressable region (i.e., an addressable region other than the addressable region that is both subsequent to and contiguous with the contiguous range) has been received. If, at step S131, it is determined that no memory access request identifying an out of sequence addressable region has been received, then flow remains at step S131. If, at step S131, it is determined that a memory access request identifying an out of sequence addressable region has been received, then flow proceeds to step S132 where it is determined if the received memory access identifies an addressable range that falls within a predefined range. If, at step S132, it is determined that the memory access does not fall within the predefined range, then flow returns to step S131. If, at step S132, it is determined that the memory access does fall within the predefined range, then flow proceeds to step S133 where the contiguous range of addresses is modified to include the addressable region indicated in the memory access. Flow then returns to step S131.

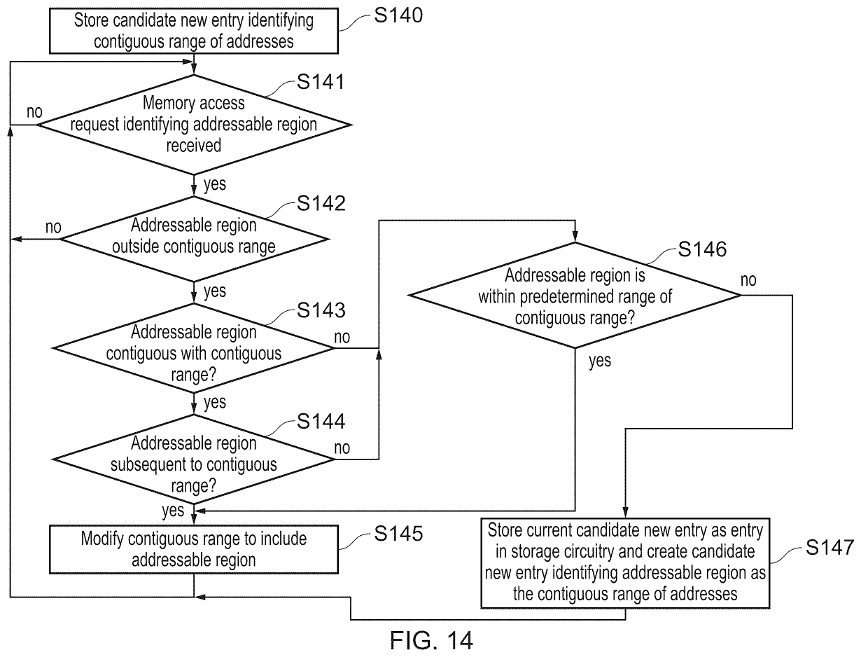

FIG. 14 schematically illustrates a sequence of steps carried out according to some configurations of the present techniques. Flow begins at step S140 where a candidate new entry is stored. The candidate new entry identifies a contiguous range of one or more addresses. Flow then proceeds to step S141 where it is determined if a memory access request identifying an addressable region has been received. If, at step S141, no memory access request identifying an addressable region is received, then flow remains at step S141. If, at step S141, a memory access request identifying an addressable region is received, then flow proceeds to step S142. At step S142 it is determined if the addressable region is outside of the contiguous range. If, at step S142, it is determined that the addressable region is not outside of the contiguous range, then flow returns to step S141. If, at step S142, it is determined that the addressable region is outside of the contiguous range, then flow proceeds to step S143. At step S143 it is determined whether the addressable region identifies a region of address space that is contiguous with the contiguous range. If, at step S143, it is determined that the addressable region identifies a region of address space that is not contiguous with the contiguous range, then flow proceeds to step S146. If, at step S143, it is determined that the addressable region identifies a region of address space that is contiguous with the contiguous range, then flow proceeds to step S144. At step S144 it is determined if the addressable region is subsequent to the contiguous range. If, at step S144, it is determined that the addressable region is not subsequent to the contiguous range, then flow proceeds to step S146. If, at step S144, it is determined that the addressable region is subsequent to the contiguous range, then flow proceeds to step S145. At step S145 the contiguous range is modified to include the addressable region before flow returns to step S141. At step S146 it is determined if the addressable region is within a predetermined range of the contiguous region. If, at step S146, it is determined that the addressable region is within the predetermined range of the contiguous range, then flow proceeds to step S145. If, at step S146, it is determined that the addressable region is not within the predetermined range of the contiguous range, then flow proceeds to step S147. At step S147, the current candidate new entry is stored as an entry in the storage circuitry and a further candidate new entry is created identifying the addressable region as the contiguous range of addresses. Flow then returns to step S141.

It will be readily apparent to the person of ordinary skill in the art that the sequence of steps set out in FIGS. 13 and 14 are for illustrative purpose only and that one or more additional steps may be incorporated. Furthermore, one or more of the steps may be performed in parallel with one another or in a different order. For example, steps S143 and S144 may be performed in either order or in parallel.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

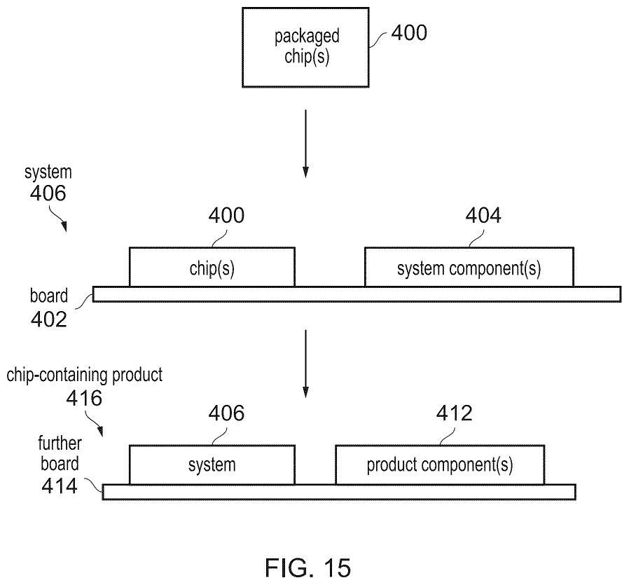

As shown in FIG. 15, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly. The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising storage circuitry to store a plurality of entries each identifying a corresponding contiguous range of addresses spanning one or more of a plurality of addressable regions. Content stored at each of the plurality of addressable regions is individually retrievable by fetch circuitry. The apparatus is also provided with control circuitry to store information indicative of a candidate new entry identifying a contiguous range of addresses. The control circuitry is responsive to receipt of an indication of a memory access request specifying an addressable region other than one of the plurality of addressable regions which is both contiguous with and subsequent to the contiguous range of addresses, to determine if the addressable region is within a predefined range. The control circuitry is responsive to the addressable region being within the predefined range, to modify the contiguous range of addresses to include the addressable region.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

### Clause 1

An apparatus comprising:
storage circuitry configured to store a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, and wherein each of the plurality of entries is suitable to be used for generation of one or more speculative memory access requests for retrieval of the content stored at the corresponding contiguous range of addresses in response to a trigger condition being satisfied; and
control circuitry configured:
   to store information indicative of a candidate new entry identifying a contiguous range of addresses spanning one or more of the plurality of addressable regions;
   in response to receipt of an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, to perform a determination of whether the addressable region is within a predefined range of the contiguous range of addresses; and
   in response to the addressable region being within the predefined range of the contiguous range of addresses, to modify the contiguous range of addresses to include the addressable region.

### Clause 2

The apparatus of clause 1, wherein the control circuitry is responsive to the determination identifying at least one intervening region between the contiguous range of addresses and the addressable region, to modify the contiguous range of addresses to include the at least one intervening region.

### Clause 3

The apparatus of clause 2, wherein the control circuitry is configured to implement a restriction on a total number of intervening regions.

### Clause 4

The apparatus of clause 3, wherein the restriction is based on a total size of the contiguous range of addresses.

### Clause 5

The apparatus of clause 3 or clause 4, wherein the restriction is based on a performance metric of the one or more speculative memory access requests.

### Clause 6

The apparatus of any preceding clause, wherein each of the plurality of addressable regions has a predefined size and the predefined range is defined in terms of the predefined size.

### Clause 7

The apparatus of clause 6, wherein the predefined range comprises addressable regions within a first range sequentially prior to the contiguous range of addresses and within a second range sequentially subsequent to the contiguous range of addresses.

### Clause 8

The apparatus of clause 7, wherein the first range and the second range are different.

### Clause 9

The apparatus of any preceding clause, wherein the control circuitry is configured:
to store first address data identifying a sequentially first region spanned by the contiguous range of addresses and size data indicating a size of the contiguous range of addresses;
in response to the addressable region being sequentially subsequent to the contiguous range of addresses, to extend the size data to include the addressable range.

### Clause 10

The apparatus of clause 9, wherein the control circuitry is responsive to the addressable region being sequentially before the contiguous range of addresses, to replace the first address data with the addressable region and to extend the size data to include the addressable range.

### Clause 11

The apparatus of any preceding clause, wherein the predefined range is dynamically adjusted based on one or more performance parameters.

### Clause 12

The apparatus of clause 11, wherein the one or more performance parameters are indicative of a performance metric of the one or more speculative memory access requests.

### Clause 13

The apparatus of any preceding clause, comprising a local storage structure, wherein each of the plurality of addressable regions is the size of an entry in the local storage structure.

### Clause 14

The apparatus of clause 13, wherein the local storage structure is a cache and each of the plurality of addressable regions is a cache line.

### Clause 15

The apparatus of any preceding clause, wherein the determination is performed over a window of memory access requests.

### Clause 16

The apparatus of any preceding clause, wherein the control circuitry is configured to store the candidate new entry in the storage circuitry as one of the plurality of entries.

### Clause 17

A system comprising:
the apparatus of any preceding clause, implemented in at least one packaged chip;
at least one system component; and
a board,
wherein the at least one packaged chip and the at least one system component are assembled on the board.

### Clause 18

A chip-containing product comprising the system of clause 17, wherein the system is assembled on a further board with at least one other product component.

### Clause 19

A method comprising:
storing a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, wherein each of the plurality of entries is suitable to be used for generation of one or more speculative memory access requests for retrieval of the content stored at the corresponding contiguous range of addresses in response to a trigger condition being satisfied;
storing information indicative of a candidate new entry identifying a contiguous range of addresses spanning one or more of the plurality of addressable regions;
in response to receiving an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, performing a determination of whether the addressable region is within a predefined range of the contiguous range of addresses; and
in response to the addressable region being within the predefined range of the contiguous range of addresses, modifying the contiguous range of addresses to include the addressable region.

### Clause 20

A non-transitory computer-readable medium storing computer-readable code for fabrication of the apparatus of any of clauses 1 to 18.

1. An apparatus comprising:
storage circuitry configured to store a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, and wherein each of the plurality of entries is suitable to be used for generation of one or more speculative memory access requests for retrieval of the content stored at the corresponding contiguous range of addresses in response to a trigger condition being satisfied; and
control circuitry configured:
to store information indicative of a candidate new entry identifying a contiguous range of addresses spanning one or more of the plurality of addressable regions;
in response to receipt of an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, to perform a determination of whether the addressable region is within a predefined range of the contiguous range of addresses; and
in response to the addressable region being within the predefined range of the contiguous range of addresses, to modify the contiguous range of addresses to include the addressable region.

2. The apparatus of claim 1, wherein the control circuitry is responsive to the determination identifying at least one intervening region between the contiguous range of addresses and the addressable region, to modify the contiguous range of addresses to include the at least one intervening region.

3. The apparatus of claim 2, wherein the control circuitry is configured to implement a restriction on a total number of intervening regions.

4. The apparatus of claim 3, wherein the restriction is based on a total size of the contiguous range of addresses.

5. The apparatus of claim 3, wherein the restriction is based on a performance metric of the one or more speculative memory access requests.

6. The apparatus of claim 1, wherein each of the plurality of addressable regions has a predefined size and the predefined range is defined in terms of the predefined size.

7. The apparatus of claim 6, wherein the predefined range comprises addressable regions within a first range sequentially prior to the contiguous range of addresses and within a second range sequentially subsequent to the contiguous range of addresses.

8. The apparatus of claim 7, wherein the first range and the second range are different.

9. The apparatus of claim 1, wherein the control circuitry is configured:
to store first address data identifying a sequentially first region spanned by the contiguous range of addresses and size data indicating a size of the contiguous range of addresses;
in response to the addressable region being sequentially subsequent to the contiguous range of addresses, to extend the size data to include the addressable range.

10. The apparatus of claim 9, wherein the control circuitry is responsive to the addressable region being sequentially before the contiguous range of addresses, to replace the first address data with the addressable region and to extend the size data to include the addressable range.

11. The apparatus of claim 1, wherein the predefined range is dynamically adjusted based on one or more performance parameters.

12. The apparatus of claim 11, wherein the one or more performance parameters are indicative of a performance metric of the one or more speculative memory access requests.

13. The apparatus of claim 1, comprising a local storage structure, wherein each of the plurality of addressable regions is the size of an entry in the local storage structure.

14. The apparatus of claim 13, wherein the local storage structure is a cache and each of the plurality of addressable regions is a cache line.

15. The apparatus of claim 1, wherein the determination is performed over a window of memory access requests.

16. The apparatus of claim 1, wherein the control circuitry is configured to store the candidate new entry in the storage circuitry as one of the plurality of entries.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
storing a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, wherein each of the plurality of entries is suitable to be used for generation of one or more speculative memory access requests for retrieval of the content stored at the corresponding contiguous range of addresses in response to a trigger condition being satisfied;
storing information indicative of a candidate new entry identifying a contiguous range of addresses spanning one or more of the plurality of addressable regions;
in response to receiving an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, performing a determination of whether the addressable region is within a predefined range of the contiguous range of addresses; and
in response to the addressable region being within the predefined range of the contiguous range of addresses, modifying the contiguous range of addresses to include the addressable region.

20. A non-transitory computer-readable medium storing computer-readable code, which when executed by one or more computers, generates a semiconductor design for fabrication of an apparatus comprising:
storage circuitry configured to store a plurality of entries, each of the plurality of entries identifying a corresponding contiguous range of addresses spanning one or more of a plurality of addressable regions of an address space, wherein content stored at each of the plurality of addressable regions is individually retrievable by fetch circuitry from a memory hierarchy, and wherein each of the plurality of entries is suitable to be used for generation of one or more speculative memory access requests for retrieval of the content stored at the corresponding contiguous range of addresses in response to a trigger condition being satisfied; and
control circuitry configured:
to store information indicative of a candidate new entry identifying a contiguous range of addresses spanning one or more of the plurality of addressable regions;
in response to receipt of an indication of a memory access request specifying an addressable region of the plurality of addressable regions, the addressable region being other than one of the plurality of addressable regions which is both contiguous with and subsequent to the one or more of the plurality of addressable regions spanned by the contiguous range of addresses, to perform a determination of whether the addressable region is within a predefined range of the contiguous range of addresses; and
in response to the addressable region being within the predefined range of the contiguous range of addresses, to modify the contiguous range of addresses to include the addressable region.
